(19) United States
(12) Patent Application Publication
(10) Pub. No.: US 2026/0317482 A1
(43) Pub. Date: Oct. 15, 2026

(54) RESIN COMPOSITION, INSULATED WIRE, AND METHOD OF MANUFACTURING INSULATED WIRE

(71) Applicants: SUMITOMO ELECTRIC WINTEC, INC., Koka-shi, Shiga (JP); SUMITOMO ELECTRIC INDUSTRIES, LTD., Osaka-shi, Osaka (JP)

(72) Inventors: Kentaro YAMADA, Koka-shi (JP); Shinya OTA, Osaka-shi (JP); Miho NISHIO, Osaka-shi (JP); Hirotsugu MOCHIDA, Koka-shi (JP)

(73) Assignees: SUMITOMO ELECTRIC WINTEC, INC., Koka-shi, Shiga (JP); SUMITOMO ELECTRIC INDUSTRIES, LTD., Osaka-shi, Osaka (JP)

(21) Appl. No.: 19/478,335

(22) PCT Filed: Feb. 5, 2024
(86) PCT No.: PCT/JP2024/003623

§ 371 Date: Oct. 24, 2025

(30) Foreign Application Priority Data
Apr. 25, 2023 (JP) 2023-071272

(51) Int. Cl. C08G 73/12; C08K 5/00; C08K 5/17; H01B 3/30; H01B 17/62; H01B 19/04

(52) U.S. Cl. CPC C08G 73/12; C08K 5/005; C08K 5/17; H01B 3/306; H01B 17/62; H01B 19/04; C08G 2150/00

(57) ABSTRACT

This resin composition contains: a polyimide precursor, which is a reaction product of an aromatic tetracarboxylic dianhydride and an aromatic diamine; an organic solvent; a pore-forming agent; and a radical scavenger.

### TECHNICAL FIELD

The present disclosure relates to a resin composition, an insulated wire, and a method of manufacturing an insulated wire. The present application claims priority to Japanese Patent Application No. 2023-071272, filed Apr. 25, 2023, which is incorporated by reference herein in its entirety.

### BACKGROUND ART

Patent Literature 1(Japanese Unexamined Patent Application Publication No. 2012-224714) describes an insulating varnish including a film-forming resin and a thermally decomposable resin that is decomposed at a temperature lower than the baking temperature for the film-forming resin, and an insulated wire having a thermally cured film from the insulating varnish wherein the thermally cured film contains pores formed by the thermal decomposition of the thermally decomposable resin.

### CITATION LIST

### Patent Literature

Patent literature 1: Japanese Unexamined Patent Application Publication No. 2012-224714

### SUMMARY OF INVENTION

A resin composition according to one aspect of the present disclosure contains a polyimide precursor that is a reaction product between an aromatic tetracarboxylic dianhydride and an aromatic diamine, an organic solvent, a pore-forming agent, and a radical scavenger.

### BRIEF DESCRIPTION OF DRAWINGS

FIG. 1 is a schematic sectional view illustrating an insulated wire according to one embodiment of the present disclosure.

### DETAILED DESCRIPTION

### Problems to be Solved by Present Disclosure

Electrical devices with a high applicable voltage, such as high-voltage motors, are subjected to a high voltage through insulated wires constituting the electrical devices. Such voltage application is likely to cause partial discharge (corona discharge) on the surface of the insulating coatings. Partial discharge can give rise to, for example, a local temperature rise, the occurrence of ozone, and the formation of ions. These consequences hasten insulation breakdown and shorten the life of the insulated wires and ultimately the life of the electrical devices. It is therefore necessary to suppress the occurrence of partial discharge. One approach that is being studied is to reduce the permittivity of insulating coatings. To reduce the permittivity of an insulating coating, the technique proposed in Patent Literature 1 forms pores in the insulating coating.

Increasing the porosity of an insulating coating can reduce the permittivity of the insulating coating but at the same time may deteriorate the coating elongation of the insulating coating. Thus, there is a demand for an insulated wire in which the insulating coating shows little or no deterioration in coating elongation associated with increasing its porosity.

An object of the present disclosure is to provide a resin composition capable of forming an insulating coating that shows little or no deterioration in coating elongation associated with increasing its porosity.

### Advantageous Effects of Present Disclosure

A resin composition according to one aspect of the present disclosure can form an insulating coating that shows little or no deterioration in coating elongation associated with increasing its porosity.

### DESCRIPTION OF EMBODIMENTS OF PRESENT DISCLOSURE

First, a list of embodiments of the present disclosure will be described.

### Item 1.

A resin composition including:
a polyimide precursor including a reaction product of an aromatic tetracarboxylic dianhydride with an aromatic diamine;
an organic solvent;
a pore-forming agent; and
a radical scavenger.

### Item 2.

The resin composition according to item 1, wherein the content of the radical scavenger is 0.1 parts by mass to 10 parts by mass per 100 parts by mass of the polyimide precursor.

### Item 3.

The resin composition according to item 1 or 2, wherein the radical scavenger is a hindered amine light stabilizer.

### Item 4.

The resin composition according to any one of items 1 to 3, wherein the pore-forming agent is thermally decomposable resin-containing particles.

### Item 5.

The resin composition according to any one of items 1 to 4, which is used to form an insulating coating in an insulated wire.

### Item 6.

An insulated wire including:
a conductor; and
an insulating coating covering the conductor, wherein
the insulating coating includes a resin matrix and a plurality of pores, and
the insulating coating is formed from the resin composition described in any one of items 1 to 5.

### Item 7.

The insulated wire according to item 6, wherein
the insulating coating has a porosity P of 20 vol % to 60 vol %, and
the insulating coating satisfies Y≥X wherein Y is a coating elongation of the insulating coating and X is a value calculated from expression (1) below:

X=−1.3×P+84. Expression (1)

### Item 8.

A method of manufacturing an insulated wire including a conductor and an insulating coating covering the conductor, the insulating coating including a resin matrix and a plurality of pores, the method including:
applying the resin composition described in any one of items 1 to 5 to an outer peripheral surface of the conductor; and
heating the resin composition having been applied.

### Details of Embodiments of Present Disclosure

Hereinafter, a resin composition, an insulated wire, and a method of manufacturing an insulated wire according to some aspects of the present disclosure will be described.

### <Resin Compositions>

The resin composition contains a polyimide precursor that is a reaction product between an aromatic tetracarboxylic dianhydride and an aromatic diamine, an organic solvent, a pore-forming agent, and a radical scavenger.

By virtue of its containing a radical scavenger, the resin composition can form an insulating coating that shows little or no deterioration in coating elongation associated with increasing its porosity. In other words, the resin composition, by containing a radical scavenger, can realize excellent coating elongation even when an insulating coating is formed with a high porosity.

The following discussion is given without wishing to limit the interpretation. It is believed that radicals are generated when a porous insulating coating is formed. The generated radicals remove hydrogen atoms from carbon-hydrogen bonds (C—H bonds) in the polyimide precursor, the cured product thereof, namely, the polyimide, or the raw materials, namely, the aromatic tetracarboxylic dianhydride and the aromatic diamine (hereinafter, these will be also written as the “polyimide precursor, etc.”) to generate carbon radicals (C·). The generated carbon radicals react with carbon radicals in other molecules of the polyimide precursor, etc. to form undesired crosslinks between polymer chains of the polyimide precursor, etc. This is probably responsible for the decrease in coating elongation of the insulating coating. It will be therefore possible to reduce the decrease in coating elongation of the insulating coating stemming from the generation of radicals, by using a radical scavenger so as to trap radicals that are generated during the formation of a porous insulating coating.

The term “porosity” means the percentage (unit: vol %) of the volume of pores relative to the volume of an insulating coating having a resin matrix and pores. Specifically, the porosity is determined as follows. The apparent volume V1 calculated from the outer diameter of the insulating coating is multiplied by the density ρ1 of the material of the insulating coating to give the mass W1 of the insulating coating assuming that the insulating coating contains no pores. The actual mass of the insulating coating is W2. The porosity is calculated from the expression: (W1−W2)×100/W1.

The term “coating elongation” means breaking elongation (unit: %). Specifically, the coating elongation is measured as follows. A conductor is removed from an insulated wire and the tubular insulating coating is used as a sample. The sample is tensile tested on a tensile tester under conditions where the chuck to chuck distance is 20 mm and the stress rate is 10 mm/min to measure the breaking elongation.

The resin composition may be suitably used as a resin composition (a resin varnish) for forming an insulating coating in an insulated wire.

The components contained in the resin composition are described below.

### (Polyimide Precursors)

The polyimide precursor is a reaction product obtained by condensation polymerization reaction between an aromatic tetracarboxylic dianhydride and an aromatic diamine. The polyimide precursor is a compound also called polyamic acid (polyamide acid). The polyimide precursor undergoes dehydration cyclization reaction to form a cyclic imide, namely, a polyimide. Although not wishing to limit the interpretation, the above curing reaction from the polyimide precursor to the polyimide is probably one of the causes of the generation of radicals.

When pyromellitic dianhydride (PMDA) is used as the aromatic tetracarboxylic dianhydride, the heat resistance of an insulating coating can be enhanced. This is because PMDA has a rigid and linear molecular structure. An aromatic tetracarboxylic dianhydride other than PMDA (hereinafter, also written as “other aromatic tetracarboxylic dianhydride”) may be used as the aromatic tetracarboxylic dianhydride.

Examples of such other aromatic tetracarboxylic dianhydrides include 3,3′,4,4′-biphenyltetracarboxylic dianhydride (s-BPDA), 2,3,3′,4′-biphenyltetracarboxylic dianhydride (a-BPDA), 2,2′,3,3′-biphenyltetracarboxylic dianhydride (i-BPDA), 3,3′,4,4′-benzophenonetetracarboxylic dianhydride, 4,4′-oxydiphthalic dianhydride, 2,2′,3,3′-benzophenonetetracarboxylic dianhydride, 2,2-bis(3,4-dicarboxyphenyl)propane dianhydride, 2,2-bis(2,3-dicarboxyphenyl)propane dianhydride, 1,1-bis(3,4-dicarboxyphenyl)ethane dianhydride, 1,1-bis(2,3-dicarboxyphenyl)ethane dianhydride, bis(3,4-dicarboxyphenyl)methane dianhydride, bis(2,3-dicarboxyphenyl)methane dianhydride, bis(3,4-dicarboxyphenyl)sulfone dianhydride, bis(3,4-dicarboxyphenyl)ether dianhydride, 1,2,5,6-naphthalenetetracarboxylic dianhydride, and 2,3,6,7-naphthalenetetracarboxylic dianhydride. Such other aromatic tetracarboxylic dianhydrides may be used singly, or two or more may be used in combination.

When biphenyltetracarboxylic dianhydride (BPDA) is used as such other aromatic tetracarboxylic dianhydride, the hydrolysis resistance of the polyimide precursor can be enhanced.

The lower limit of the content of PMDA relative to 100 mol % of the aromatic tetracarboxylic dianhydride(s) may be 0 mol %, 10 mol %, 20 mol %, or 30 mol %. The upper limit of the content of PMDA relative to 100 mol % of the aromatic tetracarboxylic dianhydride(s) may be 100 mol %, 90 mol %, 80 mol %, or 70 mol %.

The content of the other aromatic tetracarboxylic dianhydride relative to 100 mol % of the aromatic tetracarboxylic dianhydride(s) may be determined appropriately without impairing the advantageous effects of the present disclosure. The upper limit of the content may be 30 mol % or 20 mol %. The lower limit of the content may be 0 mol % or 10 mol %.

When diaminodiphenyl ether (ODA) is used as the aromatic diamine, the heat resistance of an insulating coating can be enhanced. This is because ODA has a rigid and linear molecular structure. Examples of the diaminodiphenyl ethers include 4,4′-diaminodiphenyl ether (4,4′-ODA), 3,4′-diaminodiphenyl ether (3,4′-ODA), 3,3′-diaminodiphenyl ether (3,3′-ODA), 2,4′-diaminodiphenyl ether (2,4′-ODA), and 2,2′-diaminodiphenyl ether (2,2′-ODA). 4,4′-Diaminodiphenyl ether (4,4′-ODA) can provide enhancements in the coating elongation of an insulating coating.

The lower limit of the content of ODA relative to 100 mol % of the aromatic diamine(s) may be 50 mol %, 60 mol %, or 70 mol %. The upper limit of the content of ODA relative to 100 mol % of the aromatic diamine(s) may be 100 mol % or 90 mol %.

An aromatic diamine other than ODA (hereinafter, also written as “other aromatic diamine”) may be further used as the aromatic diamine. Examples of such other aromatic diamines include 2,2-bis[4-(4-aminophenoxy)phenyl]propane (BAPP), 4,4′-bis(4-aminophenoxy)biphenyl (BAPB), 4,4′-diaminodiphenylmethane, 3,4′-diaminodiphenylmethane, 3,3′-diaminodiphenylmethane, 2,4′-diaminodiphenylmethane, 2,2′-diaminodiphenylmethane, 4,4′-diaminodiphenylsulfone, 3,4′-diaminodiphenylsulfone, 3,3′-diaminodiphenylsulfone, 2,4′-diaminodiphenylsulfone, 2,2′-diaminodiphenylsulfone, 4,4′-diaminodiphenyl sulfide, 3,4′-diaminodiphenyl sulfide, 3,3′-diaminodiphenyl sulfide, 2,4′-diaminodiphenyl sulfide, 2,2′-diaminodiphenyl sulfide, p-phenylenediamine, m-phenylenediamine, p-xylylenediamine, m-xylylenediamine, 2,2′-dimethyl-4,4′-diaminobiphenyl (mTBHG), 1,5-diaminonaphthalene, 4,4′-benzophenonediamine, 3,3′-dimethyl-4,4′-diaminodiphenylmethane, and 3,3′,5,5′-tetramethyl-4,4′-diaminodiphenylmethane. Such other aromatic diamines may be used singly, or two or more may be used in combination.

When 2,2-bis[4-(4-aminophenoxy)phenyl]propane (BAPP) or 4,4′-bis(4-aminophenoxy)biphenyl (BAPB) is used as such other aromatic diamine, the relative permittivity of an insulating coating can be lowered.

The content of the other aromatic diamine relative to 100 mol % of the aromatic diamine(s) may be determined appropriately without impairing the advantageous effects of the present disclosure. The upper limit of the content may be 40 mol % or 30 mol %. The lower limit of the content may be 0 mol % or 10 mol %.

The lower limit of the concentration of the polyimide precursor in the resin composition may be 10 mass % or 20 mass %. The upper limit of the concentration may be 50 mass % or 40 mass %. When the concentration is at or above the lower limit, the whole process of manufacturing an insulating coating using the resin composition can benefit from the reduction of the amount of the resin composition required to obtain a desired thickness of the insulating coating, and consequently the number of coating and heating repetitions can be reduced. When the concentration is at or below the upper limit, the resin composition can be adjusted to an appropriate viscosity while maintaining good film properties and thus can attain enhanced applicability.

From the point of view of the ease of synthesis of the polyimide precursor, the molar ratio of the aromatic tetracarboxylic dianhydride to the aromatic diamine (aromatic tetracarboxylic dianhydride:aromatic diamine) used as the raw materials for the polyimide precursor may be, for example, 95:105 to 105:95, 97:103 to 103:97, or 99:101 to 101:99. The amounts of the aromatic tetracarboxylic dianhydride and the aromatic diamine may be substantially equimolar amounts. In this case, the molecular weight of the polyimide precursor can be easily increased. The term “substantially equimolar amounts” means that the molar ratio of the aromatic tetracarboxylic dianhydride to the aromatic diamine (aromatic tetracarboxylic dianhydride:aromatic diamine) is in the range of 99:101 to 101:99.

### (Methods of Synthesizing the Polyimide Precursor)

The polyimide precursor may be obtained by polymerization condensation reaction between the aromatic tetracarboxylic dianhydride and the aromatic diamine. The polymerization condensation reaction may be performed in the same manner as the conventional synthesis of polyimide precursor. Specifically, for example, the polymerization condensation reaction may be performed by mixing the aromatic tetracarboxylic dianhydride and the aromatic diamine in an organic solvent. This method causes the aromatic tetracarboxylic dianhydride and the aromatic diamine to polymerize and gives a solution in which the polyimide precursor is dissolved in the organic solvent. The degree of polymerization (the weight average molecular weight) may be controlled by, for example, performing the polymerization condensation reaction in the presence of a reaction inhibitor.

Examples of the reaction inhibitors include water (H₂O) and C1-C15 alcohols. Examples of the C1-C15 alcohols include monohydric alcohols, such as ethanol, methanol, propanol, butanol, and pentanol; and polyhydric alcohols, such as ethylene glycol, propylene glycol, and glycerin.

The reaction conditions for the polymerization may be determined appropriately in accordance with factors, such as the types of raw materials that are used. For example, the reaction temperature may be 10° C. to 100° C. and the reaction time may be 0.5 hours to 24 hours.

Examples of the organic solvents used in the condensation polymerization reaction are the same as those of the organic solvents described below.

### (Organic Solvents)

For example, the organic solvent that is used may be an aprotic polar organic solvent, such as N-methyl-2-pyrrolidone (NMP), N,N-dimethylacetamide (DMAc), N,N-dimethylformamide, dimethyl sulfoxide, or γ-butyrolactone. These organic solvents may be used singly, or two or more may be used in combination. The term “aprotic polar organic solvent” indicates a polar organic solvent that does not have a proton-releasing group.

The content of the organic solvent in the resin composition is not particularly limited as long as the amount is enough to uniformly dissolve and disperse the aromatic tetracarboxylic dianhydride and the aromatic diamine. If the amount is excessively large, the formation of an insulating coating may take a long time due to the need of evaporating a large amount of the organic solvent. Thus, the content of the organic solvent may be, for example, 100 parts by mass to 1,000 parts by mass per 100 parts by mass of the total of the aromatic tetracarboxylic dianhydride and the aromatic diamine.

### (Pore-Forming Agents)

The pore-forming agent is not particularly limited and may be any known additive used to form porous insulating coatings. Examples of the pore-forming agents include chemical foaming agents, thermally expandable microcapsules, thermally decomposable resin-containing particles, high-boiling solvents, and hollow fillers. Although not wishing to limit the interpretation, some types of pore-forming agents are considered to generate radicals. For example, thermally decomposable resin-containing particles are believed to generate radicals.

When the pore-forming agent is thermally decomposable resin-containing particles, an insulating coating with a good appearance can be formed even when the porosity is high. The thermally decomposable resin-containing particles are gasified by pyrolysis and pores are left at locations within the insulating coating where the thermally decomposable resin-containing particles were present. In this case, the pores can be evenly distributed as finely dispersed phases in the continuous phase of the resin matrix constituting the insulating coating, and thus closed pores can be formed.

The thermally decomposable resin contained in the thermally decomposable resin-containing particles is preferably a resin that is thermally decomposed at a temperature lower than the baking temperature for the polyimide that is the main component of the resin matrix constituting the insulating coating. The baking temperature is determined appropriately depending on the type of polyimide but is usually about 200° C. to 600° C. The “thermal decomposition temperature” indicates the temperature at which the percentage mass loss reaches 50% when the temperature is elevated from room temperature at 10° C./min in an air atmosphere.

The thermal decomposition temperature may be determined by measuring thermal weight changes using a thermogravimetry-differential thermal analyzer (“TG/DTA” from SII NanoTechnology Inc.).

Examples of the thermally decomposable resins include resins that are alkylated, (meth)acrylated, or epoxidized at one or both ends or a portion of the molecular chain of the compounds, such as those derived from polyethylene glycol or polypropylene glycol; polymers of a (meth)acrylic acid ester having a C1-C6 alkyl group, such as polymethyl (meth)acrylate, polyethyl (meth)acrylate, polypropyl (meth)acrylate, and polybutyl (meth)acrylate; urethane oligomers; urethane polymers; polymers of a modified (meth)acrylate, such as urethane (meth)acrylate, epoxy (meth)acrylate, or ε-caprolactone (meth)acrylate; poly(meth)acrylic acid; crosslinked products thereof, polystyrenes; and crosslinked polystyrenes. Polymers of a (meth)acrylic acid ester having a C1-C6 alkyl group are easily pyrolyzed at the above baking temperature and thus easily form pores in the insulating coating. Examples of the polymers of a (meth)acrylic acid ester include polymethyl methacrylate (PMMA). The term “(meth)acrylic acid” includes both “acrylic acid” and “methacrylic acid”.

The thermally decomposable resin-containing particles may be particles consisting solely of the above-described thermally decomposable resin or may be core-shell particles that have a core based on the above thermally decomposable resin and a shell based on a resin having a thermal decomposition temperature higher than the thermal decomposition temperature of the thermally decomposable resin. When the resin varnish contains core-shell particles, only the cores are pyrolyzed by heating to form pores and the shells remain as the outer peripheral surface of these pores. Core-shell particles can form pores with no or less interconnection and thus can reduce the variation in pore size.

The main component of the shells is not particularly limited as long as the material has a higher thermal decomposition temperature than the cores. A synthetic resin with a low permittivity and high heat resistance is suitable. Examples include polystyrenes, silicones, fluororesins, and polyimides. Silicones tend to give high elasticity and thereby facilitate enhancing the dispersibility of pores in the insulating coating, offering excellent insulation and heat resistance.

The content of the pore-forming agent in the resin composition may be determined appropriately in accordance with factors, such as, for example, the type of pore-forming agent and the target porosity of the insulating coating.

### (Radical Scavengers)

In the present disclosure, the term “radical scavenger” means not only a radical scavenger in the narrow sense that captures free radicals generated in the early stage of oxidation (a primary antioxidant), but also a radical scavenger in the broad sense including a peroxide decomposer that decomposes peroxides generated by the reaction of free radicals into harmless substances (a secondary antioxidant). Any radical scavenger in the narrow sense or any peroxide decomposer described above may be used as the radical scavenger without limitation. It is probable that the resin composition, by containing the radical scavenger, can trap radicals that are generated during the formation of a porous insulating coating and consequently the insulating coating suffers little or no deterioration in coating elongation stemming from the generation of radicals.

Examples of the radical scavengers include hindered amine light stabilizers (HALS), phenolic antioxidants, aromatic amine antioxidants, sulfur antioxidants, and phosphorus antioxidants. In general, hindered amine light stabilizers, phenolic antioxidants, and aromatic amine antioxidants are classified as antioxidants in the narrow sense described above, and sulfur antioxidants and phosphorus antioxidants are classified as peroxide decomposers. The resin composition may contain one, or two or more radical scavengers.

Examples of the hindered amine light stabilizers include bis(1,2,2,6,6-pentamethyl-4-piperidyl) sebacate, 1,2,2,6,6-pentamethyl-4-piperidyl methacrylate, tetrakis(1,2,2,6,6-pentamethyl-4-piperidyl)butane-1,2,3,4-tetracarboxylate, (2,2,6,6-tetramethyl-4-piperidyl)dodecylsuccinimide, and N,N′-bis(2,2,6,6-tetramethyl-4-piperidyl)butane tetracarboxylate.

Examples of the phenolic antioxidants include 2,6-di-tert-butyl-p-cresol (BHT), 2,4,6-tris(3′,5′-di-tert-butyl-4′-hydroxybenzyl)mesitylene, 2,2′-methylenebis(6-tert-butyl-4-ethylphenol), pentaerythritol tetrakis[3-(3,5-di-tert-butyl-4-hydroxyphenyl) propionate], 2,5-di-t-butylhydroquinone, N,N′-hexamethylenebis(3,5-di-t-butyl-4-hydroxyhydrocinnamide, 3,5-di-t-butyl-4-hydroxy-benzylphosphonate-diethyl ester, 2,4-bis[(octylthio)methyl]-o-cresol, 2,6-di-t-butyl-4-ethylphenol, 2,2′-methylenebis(4-methyl-6-t-butylphenol), 2,2′-methylenebis(4-ethyl-6-t-butylphenol), 4,4′-butylidenebis(3-methyl-6-t-butylphenol), 2,5-di-t-amylhydroquinone, 2-t-butyl-6-(3-butyl-2-hydroxy-5-methylbenzyl)-4-methylphenyl acrylate, and 4,4′-butylidenebis(3-methyl-6-t-butylphenol).

Examples of the aromatic amine antioxidants include N,N′-di-2-naphthyl-1,4-phenylenediamine and 4,4′-bis(α,α-dimethylbenzyl)diphenylamine.

Examples of the sulfur antioxidants include phenothiazine, pentaerythritol-tetrakis(3-laurylthiopropionate), didodecyl sulfide, dioctadecyl sulfide, didodecyl thiodipropionate, dioctadecyl thiodipropionate, dimyristyl thiodipropionate, dodecyl octadecyl thiodipropionate, and 2-mercaptobenzimidazole.

Examples of the phosphorus antioxidants include triisodecyl phosphite, diphenyl isodecyl phosphite, triphenyl phosphite, and trinonylphenyl phosphite.

The following discussion is given without wishing to limit the interpretation. A radical scavenger in the narrow sense (a primary antioxidant) can capture free radicals that are generated in the upstream stage of oxidation and thus can prevent downstream chain reactions from occurring. Thus, a primary antioxidant is probably capable of reducing more effectively the deterioration in coating elongation of an insulating coating stemming from the generation of radicals as compared to a secondary antioxidant. Furthermore, the combined use of a radical scavenger in the narrow sense (a primary antioxidant) and a peroxide decomposer (a secondary antioxidant) makes it possible to capture free radicals generated in the upstream stage of oxidation and also to decompose and render harmless peroxides generated by the reaction of free radicals in the downstream stage of oxidation. It is therefore probable that the combined use will reduce the deterioration in coating elongation of an insulating coating more effectively.

When the radical scavenger is a hindered amine light stabilizer, the coating elongation can be further enhanced even when the porosity is high.

The lower limit of the content of the radical scavenger in the resin composition may be 0.1 parts by mass or more, 0.5 parts by mass or more, or 1 part by mass or more per 100 parts by mass of the polyimide precursor. The upper limit of the content of the radical scavenger may be 10 parts by mass or less, or 5 parts by mass or less per 100 parts by mass of the polyimide precursor. The above range of the content of the radical scavenger ensures that the coating elongation will be further enhanced even when the porosity is high. When the content of the radical scavenger is 1 part by mass to 5 parts by mass, the flexibility of an insulating coating can be enhanced.

### (Additional Components)

The resin composition may contain additional components other than the components described above. The additional components are not particularly limited and may be any additives that are added to resin varnishes for forming insulating coatings in insulated wires. Examples include antioxidants other than the radical scavengers described hereinabove, fillers, leveling agents, curing agents, and adhesion aids.

### <Insulated Wires>

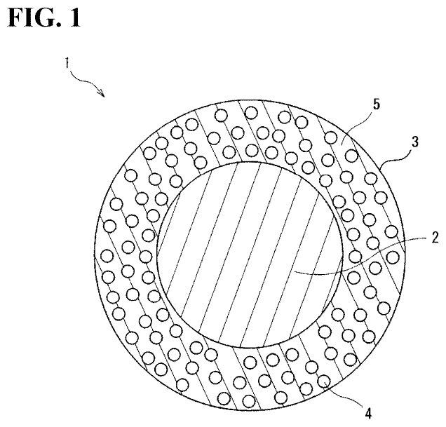

An insulated wire 1 illustrated in FIG. 1 includes a conductor 2 and an insulating coating 3 covering the conductor 2. The insulating coating 3 contains a resin matrix 5 and a plurality of pores 4.

The cross-sectional shape of the insulated wire 1 is not particularly limited and may be, for example, circular (a round wire), elliptical, square (a square wire), or rectangular (a rectangular wire). It is preferable that the cross-sectional shape of the insulated wire 1 be rectangular. In other words, the insulated wire is preferably a rectangular wire. In this case, the insulated wire 1 can be wound with a high density at the time of coil processing. It is also preferable that the cross-sectional shape of the insulated wire 1 be similar to the cross-sectional shape of the conductor 2 described later.

The insulated wire 1 may be suitably used as a coiling/winding wire (a magnet wire).

### (Conductors)

The cross-sectional shape of the conductor 2 may be, for example, circular (a round wire), elliptical, square, or rectangular. When the insulated wire 1 is formed as a rectangular wire, the cross-sectional shape of the conductor 2 is preferably rectangular.

The material of the conductor 2 is preferably a metal with high electrical conductivity and high mechanical strength. Examples of such metals include copper, copper alloys, aluminum, nickel, silver, soft iron, steel, and stainless steel. The conductor 2 may be a wire of the above metal or a multilayer structure in which a wire-shaped material is further coated with other metal, such as a nickel-coated copper wire, a silver-coated copper wire, a copper-coated aluminum wire, or a copper-coated steel wire.

The lower limit of the average sectional area of the conductor 2 may be 0.01 mm² or 0.1 mm². In this case, the insulated wire 1 has an appropriate volume of the insulating coating 3 relative to the conductor 2, and the volumetric efficiency of a coil or the like formed with the insulated wire can be enhanced. The upper limit of the average sectional area of the conductor 2 may be 20 mm² or 10 mm². In this case, a large thickness of the insulating coating 3 is less required in order to obtain a sufficiently low relative permittivity, which enables avoiding an unnecessary increase in the diameter of the insulated wire.

### (Insulating Coatings)

The insulating coating 3 is laminated on the outer peripheral surface of the conductor 2 so as to cover the conductor 2. The insulating coating 3 is composed of one or more layers. When, for example, the insulating coating 3 is formed by the method described later (in which the resin varnish is applied and baked multiple times), the insulating coating 3 has a stack structure composed of a plurality of layers formed from the resin varnish.

The insulating coating 3 contains a resin matrix 5 and a plurality of pores 4 scattered in the resin matrix 5. The insulating coating 3 is formed from the resin composition described hereinabove. Thus, the resin matrix 5 is based on the polyimide.

The porosity of the insulating coating 3 is preferably 20 vol % to 60 vol %. By virtue of the porosity of the insulating coating 3 being 20 vol % or more, the permittivity of the insulating coating can be reduced. Because the insulating coating 3 is formed from the resin composition described hereinabove, coating elongation is excellent even when the porosity is as high as 20 vol % or more. The porosity of the insulating coating 3 may be 40 vol % or more. The upper limit of the porosity of the insulating coating 3 may be 60 vol % or 50 vol %. When the porosity of the insulating coating 3 is 60 vol % or less, the insulating coating 3 can be enhanced in workability while maintaining toughness.

The insulating coating 3 exhibits excellent coating elongation even when the porosity is high. Specifically, when the porosity P is 20 vol % to 60 vol %, it is preferable that the insulating coating 3 satisfy Y≥X wherein Y is the coating elongation of the insulating coating and X is a value calculated from expression (1): X=−1.3×P+84. When the coating elongation Y is equal to or greater than the value X, it can be said that the decrease in coating elongation is small in spite of high porosity.

The average thickness of the insulating coating 3 is not particularly limited and may be usually 2 μm to 200 μm.

### (Pores)

The pores 4 preferably originate from thermally decomposable resin-containing particles. The thermally decomposable resin-containing particles are gasified by pyrolysis and pores 4 are left at locations within the insulating coating 3 where the thermally decomposable resin-containing particles were present. In this case, the pores can be evenly distributed as finely dispersed phases in the continuous phase of the resin matrix 5 constituting the insulating coating 3, and thus closed pores can be formed. The insulated wire can attain a low relative permittivity by virtue of the insulating coating 3 containing a plurality of pores 4.

The lower limit of the average diameter of the pores 4 may be 0.1 μm. In this case, the insulating coating 3 can be enhanced in mechanical properties. The upper limit of the average diameter of the pores 4 may be 10 μm. In this case, the insulating coating 3 can be enhanced in insulating properties. The average diameter of the pores 4 is a value obtained by analyzing a cross section of the insulated wire 1 with a pore diameter distribution analyzer (for example, “Porous Material Automated Pore Size Distribution Measuring System” from Porous Materials, Inc.).

The insulated wire may have a configuration other than those described above. For example, the insulated wire may have an adhesion layer containing such an additive as an adhesion improver, between the conductor and the insulating coating. Examples of the adhesion improvers include mercaptans, such as 2-mercaptoimidazole and 5-amino-1,3,4-thiadiazole-2-thiol.

The insulated wire may have a surface friction control layer as the outermost layer. Examples of the surface friction control layers include polyamide-imide layers, self-lubricating amide-imide layers, polyimide layers, and self-lubricating polyimide layers. The term “outermost layer” means the layer located on the outermost side of the stack structure constituting the insulated wire, opposite from the conductor side that is considered in this case to be on the inside.

The insulated wire may have, as the outermost layer, a fusion bonded layer containing such an additive as a foaming agent. Examples of the foaming agents include azo foaming agents, such as azodicarbonamide and azobisisobutyronitrile; nitroso foaming agents, such as dinitrosopentamethylenetetramine and N,N′-dinitroso-N,N′-dimethylterephthalamide; hydrazide foaming agents, such as p-toluenesulfonylhydrazide, p,p′-oxybisbenzenesulfonylhydrazide, and benzenesulfonylhydrazide; and trihydrazinotriazine.

The insulated wire may have, as the outermost layer, an anti-surge layer containing an inorganic filler.

Examples of the anti-surge layers include silica, alumina, magnesia, beryllium oxide, silicon carbide, titanium carbide, boron carbide, tungsten carbide, boron nitride, and silicon nitride. The inorganic filler may be surface-treated. Examples of the surface treatment agents include silane coupling agents.

### <Methods of Manufacturing Insulated Wires>

The method of manufacturing an insulated wire is a method of manufacturing the insulated wire described above, and includes applying the resin composition to the outer peripheral surface of the conductor (an application step); and heating the resin composition having been applied in the application step (a heating step).

In the application step, the resin composition is applied to the outer peripheral surface of the conductor. For example, the resin composition may be applied to the outer peripheral surface of the conductor using an applicator equipped with a liquid composition tank that stores the resin composition, and a coating die. The applicator is configured such that the resin composition is attached to the outer peripheral surface of the conductor as the conductor goes in and passes through the liquid composition tank, and the thickness of the resin composition that has been attached is rendered uniform as the conductor passes through the coating die.

In the heating step, the resin composition that has been applied to the conductor in the application step is heated. This heating evaporates the organic solvent in the resin composition and cures the polyimide precursor to form the polyimide.

The apparatus used in the heating step is not particularly limited and may be, for example, a cylindrical baking furnace that is long along the direction of the travel of the conductor. The heating method is not particularly limited, and heating may be performed by any conventionally known method, such as, for example, hot air heating, infrared heating, or high-frequency heating.

The heating temperature may be, for example, 300° C. to 800° C. The heating time may be, for example, 5 seconds to 1 minute.

The application step and the heating step are usually repeated multiple times. Repetitions increase the thickness of the insulating coating. The orifice diameter of the coating die may be adjusted appropriately in accordance with the number of repetitions.

### Examples

The present disclosure will be described in greater detail below by way of EXAMPLES. The present disclosure is not limited to these EXAMPLES.

### <Preparation of Resin Compositions and Manufacturing of Insulated Wires>

The components used in the preparation of resin compositions are abbreviated as follows.

### (Aromatic Tetracarboxylic Dianhydrides)

PMDA: pyromellitic dianhydride
BPDA: 3,3′,4,4′-biphenyltetracarboxylic dianhydride

### (Aromatic Diamines)

ODA: 4,4′-diaminodiphenyl ether
BAPP: 2,2-bis[4-(4-aminophenoxy)phenyl]propane
BAPB: 4,4′-bis(4-aminophenoxy)biphenyl

### (Organic Solvent)

NMP: N-methyl-2-pyrrolidone

### (Radical Scavengers)

HALS 1: bis(1,2,2,6,6-pentamethyl-4-piperidyl) sebacate (“ADK STAB LA-72” from ADEKA CORPORATION)
HALS 2: 1,2,2,6,6-pentamethyl-4-piperidyl methacrylate (“ADK STAB LA-82” from ADEKA CORPORATION)
HALS 3: tetrakis(1,2,2,6,6-pentamethyl-4-piperidyl)butane-1,2,3,4-tetracarboxylate (“ADK STAB LA-52” from ADEKA CORPORATION)
Phenol 1: 2,6-di-tert-butyl-p-cresol (“D0228” from Tokyo Chemical Industry Co., Ltd.)
Phenol 2: 2,4,6-tris(3′,5′-di-tert-butyl-4′-hydroxybenzyl)mesitylene (“T0916” from Tokyo Chemical Industry Co., Ltd.)
Amine 1: N,N′-di-2-naphthyl-1,4-phenylenediamine (“D0812” from Tokyo Chemical Industry Co., Ltd.)
Amine 2: 4,4′-bis(α,α-dimethylbenzyl)diphenylamine (“B1970” from Tokyo Chemical Industry Co., Ltd.)

### [No. 1]

### (Preparation of Resin Composition)

ODA as an aromatic diamine was dissolved into NMP. PMDA as an aromatic tetracarboxylic dianhydride was added so that the mixing ratio (by mole) of the aromatic tetracarboxylic dianhydride to the aromatic diamine would be 100:100. The mixture was reacted at 30° C. for 3 hours while performing stirring under a nitrogen atmosphere to synthesize a polyimide precursor. A polyimide precursor in NMP solution was thus obtained (solid concentration: 28 mass %). 0.5 Parts by mass of HALS 1 and 40 parts by mass of thermally decomposable resin-containing particles were added to 100 parts by mass of the polyimide precursor. Resin composition No. 1 was thus prepared. The thermally decomposable resin-containing particles used here were core-shell particles with an average particle size of 3 μm in which the core was a polymethyl methacrylate particle and the shell was silicone.

### (Manufacturing of Insulated Wire)

A round copper wire having an average diameter of 1 mm was used as a conductor. Resin composition No. 1 was applied to the surface of the conductor. The conductor coated with resin composition No. 1 was heated in a heating furnace under conditions where the inlet temperature was 400° C., the outlet temperature was 500° C., and the wire speed was 13 m/min. These steps were repeated 13 times. Thus, an insulating coating having an average thickness of 40 μm was formed on the conductor. Insulated wire No. 1 was thus manufactured.

### [No. 2 to No. 31]

Resin compositions No. 2 to No. 31 were prepared in the same manner as No. 1, except that the types and the amounts of the components were changed as described in Table 1. Insulated wires No. 2 to No. 31 were manufactured in the similar manner.

### <Evaluations>

Insulated wires No. 1 to No. 31 manufactured above were tested by the following methods to calculate or measure the porosity, the relative permittivity, and the coating elongation. The results are described in Table 1.

### [Calculation of Porosity]

For each of insulated wires No. 1 to No. 31 manufactured above, the tube of the insulating coating was peeled off from the conductor and the mass W2 of the cylindrical insulating coating was measured. The apparent volume V1 was determined from the outer diameter of the cylindrical insulating coating, and the volume V1 was multiplied by the density ρ1 of the material of the insulating coating. The mass W1 was thus calculated assuming that the insulating coating contained no pores. From the values of W1 and W2, the porosity (unit: vol %) was calculated using the expression below. In the calculation of the porosity, n=3 and the results were averaged.

porosity=(W1−W2)×100/W1 Expression

### [Measurement of Relative Permittivity]

The relative permittivity of the insulating coating was measured for each of insulated wires No. 1 to No. 31 manufactured above. A measurement sample was prepared by applying a silver paste to three locations on the surface of the insulated wire and peeling off the insulating coating at one end of the insulated wire to expose the conductor. Here, the lengths, in the longitudinal direction of the insulated wire, of the silver paste applied to three locations on the surface of the insulated wire were sequentially 10 mm, 100 mm, and 10 mm along the longitudinal direction. The two 10 mm long silver pastes were grounded, and the electrostatic capacitance between the 100 mm long silver paste located between the two silver pastes, and the exposed conductor was measured with an LCR meter. The relative permittivity of the insulating coating was calculated from the thus-measured electrostatic capacitance and the average thickness of the insulating coating. The measurement of relative permittivity was performed after the insulated wire had been heated at 105° C. for 1 hour. The results (n=3) were averaged.

### [Measurement of Coating Elongation]

For each of insulated wires No. 1 to No. 31 manufactured above, the conductor was removed from the insulated wire and the tube of the insulating coating was subjected to a tension with a tensile tester (“Autograph AGS-X” from Shimadzu Corporation) at 25° C. under conditions where the chuck to chuck distance was 20 mm and the stress rate was 10 mm/min. The elongation at break (unit: %) was thus measured. In the measurement of coating elongation, n=5 and the results were averaged.

### [Relationship Between the Porosity and the Coating Elongation]

Based on the porosity and the coating elongation calculated or measured above, whether the coating elongation of the insulating coating was excellent in spite of the high porosity was evaluated. The evaluation was made by comparing the value X calculated from expression (1) below where P is the porosity (vol %), with the measured value Y of coating elongation. The rating was “A” when the coating elongation in relation to 20 vol % or more porosity P satisfied Y≥X (the insulating coating had excellent coating elongation in spite of the high porosity). The rating was “B” when Y≥X was not satisfied (i.e., when Y<X) (the insulated wire was poor in coating elongation when the porosity was high).

X=−1.3×P+84(P≥20) Expression (1)

In Table 1 below, “−” indicates that the corresponding component was not used. In the “Polyimide precursor” row, “Acid anhydride” means “Aromatic tetracarboxylic dianhydride”, and “Diamine” means “Aromatic diamine”. In the “Acid anhydride” and “Diamine” columns, “Composition ratio” indicates the molar ratio. In the “Pore-forming agent” and “Radical scavenger” columns, the values indicate parts by mass per 100 parts by mass of the polyimide precursor.

TABLE 1

| | Resin composition | | | | | | | | |
|---|---|---|---|---|---|---|---|---|---|
| | | | | | | | | | Pore- |
| | | | | | | | | | forming |
| | | | | | | | | | agent |
| | Polyimide precursor | | | | | | | | Content |
| | Acid anhydride | | | | Diamine | | | | (parts |
| | Acid | Acid | Composition | | | | Composition | | by |
| | anhydride1 | anhydride2 | ratio | | Diamine1 | Diamine2 | ratio | | mass) |
| No.1 | PMDA | — | 100 | — | ODA | — | 100 | — | 40 |
| No.2 | PMDA | — | 100 | — | ODA | — | 100 | — | 40 |
| No.3 | PMDA | — | 100 | — | ODA | — | 100 | — | 40 |
| No.4 | PMDA | — | 100 | — | ODA | — | 100 | — | 40 |
| No.5 | PMDA | — | 100 | — | ODA | — | 100 | — | 40 |
| No.6 | PMDA | — | 100 | — | ODA | — | 100 | — | 76 |
| No.7 | PMDA | — | 100 | — | ODA | — | 100 | — | 76 |
| No.8 | PMDA | — | 100 | — | ODA | — | 100 | — | 76 |
| No.9 | PMDA | — | 100 | — | ODA | — | 100 | — | 76 |
| No.10 | PMDA | — | 100 | — | ODA | — | 100 | — | 76 |
| No.11 | PMDA | — | 100 | — | ODA | — | 100 | — | 76 |
| No.12 | PMDA | — | 100 | — | ODA | — | 100 | — | 76 |
| No.13 | PMDA | — | 100 | — | ODA | — | 100 | — | 76 |
| No.14 | PMDA | — | 100 | — | ODA | — | 100 | — | 76 |
| No.15 | PMDA | — | 100 | — | ODA | — | 100 | — | 76 |
| No.16 | PMDA | — | 100 | — | ODA | — | 100 | — | 76 |
| No.17 | PMDA | — | 100 | — | ODA | — | 100 | — | 76 |
| No.18 | PMDA | — | 100 | — | ODA | — | 100 | — | 76 |
| No.19 | PMDA | — | 100 | — | ODA | — | 100 | — | 123 |
| No 20 | PMDA | — | 100 | — | ODA | — | 100 | — | 123 |
| No.21 | PMDA | BPDA | 50 | 50 | ODA | — | 100 | — | 40 |
| No.22 | PMDA | BPDA | 50 | 50 | ODA | — | 100 | — | 40 |
| No.23 | PMDA | BPDA | 30 | 70 | ODA | — | 100 | — | 40 |
| No.24 | PMDA | BPDA | 30 | 70 | ODA | — | 100 | — | 40 |
| No.25 | PMDA | — | 100 | — | ODA | BAPP | 50 | 50 | 40 |
| No.26 | PMDA | — | 100 | — | ODA | BAPP | 50 | 50 | 40 |
| No.27 | PMDA | — | 100 | — | ODA | BAPB | 50 | 50 | 40 |
| No.28 | PMDA | — | 100 | — | ODA | — | 100 | — | 40 |
| No.29 | PMDA | — | 100 | — | ODA | — | 100 | — | 76 |
| No.30 | PMDA | — | 100 | — | ODA | — | 100 | — | 123 |
| No.31 | PMDA | BPDA | 30 | 70 | ODA | — | 100 | — | 40 |

| | Resin composition | | | | | | | |
|---|---|---|---|---|---|---|---|---|
| | Radical scavenger | | | | | | | |
| | Radical scavenger1 | | Radical scavenger2 | | Evaluations | | | |
| | | Content | | Content | | | Coating | |
| | | (parts by | | (parts by | Porosity | Relative | elongation | |
| | Type | mass) | Type | mass) | (vol %) | permittivity | (%) | Rating |
| No.1 | HALS1 | 0.5 | — | — | 25 | 2.4 | 57 | A |
| No.2 | HALS1 | 2.0 | — | — | 26 | 2.4 | 60 | A |
| No.3 | HALS1 | 5.0 | — | — | 26 | 2.4 | 68 | A |
| No.4 | HALS1 | 10.0 | — | — | 27 | 2.4 | 56 | A |
| No.5 | HALS1 | 2.0 | Phenol1 | 0.5 | 25 | 2.5 | 70 | A |
| No.6 | HALS1 | 0.5 | — | — | 39 | 2.1 | 44 | A |
| No.7 | HALS1 | 2.0 | — | — | 39 | 2.0 | 47 | A |
| No.8 | HALS1 | 5.0 | — | — | 38 | 2.1 | 54 | A |
| No.9 | HALS2 | 0.5 | — | — | 39 | 2.1 | 39 | A |
| No.10 | HALS2 | 2.0 | — | — | 39 | 2.0 | 45 | A |
| No.11 | HALS3 | 0.5 | — | — | 39 | 2.1 | 38 | A |
| No.12 | HALS3 | 2.0 | — | — | 38 | 2.1 | 42 | A |
| No.13 | Phenol1 | 0.5 | — | — | 38 | 2.2 | 40 | A |
| No.14 | Phenol2 | 2.0 | — | — | 38 | 2.2 | 39 | A |
| No.15 | Amine1 | 0.5 | — | — | 39 | 2.1 | 41 | A |
| No.16 | Amine2 | 0.5 | — | — | 38 | 2.1 | 41 | A |
| No.17 | HALS1 | 2.0 | Phenol1 | 0.5 | 38 | 2.1 | 51 | A |
| No.18 | HALS1 | 2.0 | Amine1 | 0.5 | 38 | 2.1 | 53 | A |
| No.19 | HALS1 | 2.0 | — | — | 45 | 1.8 | 31 | A |
| No 20 | HALS2 | 2.0 | — | — | 44 | 1.9 | 29 | A |
| No.21 | HALS1 | 2.0 | — | — | 27 | 2.5 | 53 | A |
| No.22 | HALS1 | 2.0 | Phenol1 | 0.5 | 27 | 2.4 | 54 | A |
| No.23 | HALS1 | 2.0 | — | — | 26 | 2.4 | 66 | A |
| No.24 | HALS1 | 2.0 | Phenol1 | 0.5 | 27 | 2.4 | 57 | A |
| No.25 | HALS1 | 2.0 | — | — | 28 | 2.3 | 50 | A |
| No.26 | HALS1 | 2.0 | Phenol1 | 0.5 | 27 | 2.3 | 52 | A |
| No.27 | HALS1 | 2.0 | — | — | 27 | 2.3 | 50 | A |
| No.28 | — | — | — | — | 24 | 2.2 | 51 | B |
| No.29 | — | — | — | — | 37 | 2.2 | 34 | B |
| No.30 | — | — | — | — | 42 | 2.1 | 25 | B |
| No.31 | — | — | — | — | 26 | 2.4 | 45 | B |

As can be seen from Table 1, resin compositions No. 1 to No. 27 gave insulating coatings having excellent coating elongation in spite of the high porosity, as compared to when resin compositions No. 28 to No. 31 were used.

It is to be understood that the embodiments disclosed herein are only illustrative and are not restrictive in all respects. The scope of the present disclosure is not limited to the configurations of the embodiments or to EXAMPLES but is defined by the claims. The scope of the present disclosure is intended to include all the modifications within the meaning and range of equivalents of the claims.

### REFERENCE SIGNS LIST

1 insulated wire
2 conductor
3 insulating coating
4 pore
5 resin matrix

1. A resin composition comprising:
a polyimide precursor comprising a reaction product of an aromatic tetracarboxylic dianhydride with an aromatic diamine;
an organic solvent;
a pore-forming agent; and
a radical scavenger.

2. The resin composition according to claim 1, wherein the content of the radical scavenger is 0.1 parts by mass to 10 parts by mass per 100 parts by mass of the polyimide precursor.

3. The resin composition according to claim 1, wherein the radical scavenger is a hindered amine light stabilizer.

4. The resin composition according to claim 1, wherein the pore-forming agent is thermally decomposable resin-containing particles.

5. The resin composition according to claim 1, which is used to form an insulating coating in an insulated wire.

6. An insulated wire comprising:
a conductor; and
an insulating coating covering the conductor, wherein
the insulating coating includes a resin matrix and a plurality of pores, and
the insulating coating is formed from the resin composition described in claim 1.

7. The insulated wire according to claim 6, wherein
the insulating coating has a porosity P of 20 vol % to 60 vol %, and
the insulating coating satisfies Y≥X wherein Y is a coating elongation of the insulating coating and X is a value calculated from expression (1) below:
X=−1.3×P+84. Expression (1)

8. A method of manufacturing an insulated wire comprising a conductor and an insulating coating covering the conductor, the insulating coating including a resin matrix and a plurality of pores, the method comprising:
applying the resin composition described in claim 1 to an outer peripheral surface of the conductor; and
heating the resin composition having been applied.

9. The resin composition according to claim 2, wherein the radical scavenger is a hindered amine light stabilizer.

10. The resin composition according to claim 2, wherein the pore-forming agent is thermally decomposable resin-containing particles.

11. The resin composition according to claim 3, wherein the pore-forming agent is thermally decomposable resin-containing particles.

12. The resin composition according to claim 2, which is used to form an insulating coating in an insulated wire.

13. The resin composition according to claim 3, which is used to form an insulating coating in an insulated wire.

14. The resin composition according to claim 4, which is used to form an insulating coating in an insulated wire.

15. An insulated wire comprising:
a conductor; and
an insulating coating covering the conductor, wherein
the insulating coating includes a resin matrix and a plurality of pores, and
the insulating coating is formed from the resin composition described in claim 2.

16. An insulated wire comprising:
a conductor; and
an insulating coating covering the conductor, wherein
the insulating coating includes a resin matrix and a plurality of pores, and
the insulating coating is formed from the resin composition described in claim 3.

17. An insulated wire comprising:
a conductor; and
an insulating coating covering the conductor, wherein
the insulating coating includes a resin matrix and a plurality of pores, and
the insulating coating is formed from the resin composition described in claim 4.

18. An insulated wire comprising:
a conductor; and
an insulating coating covering the conductor, wherein
the insulating coating includes a resin matrix and a plurality of pores, and
the insulating coating is formed from the resin composition described in claim 5.

19. The insulated wire according to claim 15, wherein
the insulating coating has a porosity P of 20 vol % to 60 vol %, and
the insulating coating satisfies Y≥X wherein Y is a coating elongation of the insulating coating and X is a value calculated from expression (1) below:
X=−1.3×P+84. Expression (1)

20. The insulated wire according to claim 16, wherein
the insulating coating has a porosity P of 20 vol % to 60 vol %, and
the insulating coating satisfies Y≥X wherein Y is a coating elongation of the insulating coating and X is a value calculated from expression (1) below:
X=−1.3×P+84. Expression (1)
